(19) United States
(12) Patent Application Publication
(10) Pub. No.: US 2009/0100450 A1
(43) Pub. Date: Apr. 16, 2009

(54) GEAR HOLDER IN AN OPTICAL DISK DRIVE

(75) Inventor: Jen-Chen Wu, Guishan Shiang (TW)

Correspondence Address: G. LINK CO., LTD., 3550 BELL ROAD, MINOOKA, IL, 60447, US

(73) Assignee: QUANTA STORAGE INC., GUISHAN SHIANG (TW)

(21) Appl. No.: 12/108,201

(22) Filed: Apr. 23, 2008

(30) Foreign Application Priority Data
Oct. 12, 2007 (TW) 096138568

(51) Int. Cl. G11B 17/03

(52) U.S. Cl. 720/601

(57) ABSTRACT

The invention is to provide a gear holder in an optical disk drive, wherein a bolt upwardly protrudes from the bottom of a casing. A screw hole is disposed in the center of the bolt inserted by a wheel hole on the center of a gear. The height of the wheel hole is lower than the height of the bolt. A ring flange protrudes under the peripheral of a through hole disposed on a support cover. The width of the ring flange is equal to the width of the bolt, and the height thereof is equal to the height difference from the bolt to the wheel hole. The support cover is fastened on the bolt by a screw screwed in the screw hole, and then the gear is held and rotates between the casing and the support cover. The ring flange presses on the top of the bolt to maintain a rotation space.

### FIELD OF THE INVENTION

The present invention relates to an optical disk drive, and more particularly, to a gear holder for supporting a gear to rotate smoothly in an optical disk drive.

### BACKGROUND OF THE INVENTION

Given the large data storage capacity and low prices of optical disks, optical disk drives have become the main stream of media information players. When media information is being played, the noise generated by an optical disk drive needs to be lowered most besides keeping the environment quiet, so that the audio-visual entertainment is not disturbed.

Please refer to FIG. 1, which shows a conventional slot-in optical disk drive 10. The slot-in optical disk drive 10 includes a casing 11. A traverse 12 is disposed in the casing 11. A spindle motor 13 for rotating an optical disk D is disposed on one end of the traverse 12. A pick-up head 14 is disposed on a radial direction of the spindle motor 13. The other end of the traverse 12 is pivotally connected to the casing 11 of the slot-in optical disk drive 10. A transmission motor 15 is disposed on an exit of the slot-in optical drive 10 and nearby the traverse 12. A gear module 16 is connected to the transmission motor 15 and includes a worm gear and a plurality of gears mutually connected for transmission. The gear module 16 covered by a support cover 17 (as shown in dashed lines) is fixed onto the casing 11. The other end of the gear module 16 engages with a rack of a slider 18 to drive the slider 18 to jointly drive a loading arm 19, a unloading arm 20, a locating shaft arm 21, the traverse 12 and so on.

When the slot-in optical disk drive 10 loads an optical disk, the end of traverse 12 where spindle motor 13 is disposed on shifts down to the bottom of the casing 11, so that the protruding spindle motor 13 is away from the path along which the optical disk D is drawn in. When the slot-in optical disk drive 10 detects that the optical disk D is inserted, the transmission motor 15 starts to rotate the gear module 16 to drive the slider 18 to move backwardly along the front and rear sides of the slot-in optical disk drive 10 to jointly drive the loading arm 19, the unloading arm 20 and the locating arm 21 to turn the optical disk D to a fixed location. Then, the slider 18 drives the traverse 12 to rise for the spindle motor 13 to be inserted in a center hole of the optical disk D to rotate the optical disk D, and the pick-up head 14 moves back and forth to perform reading and writing. On the other hand, when the slot-in optical disk drive 10 unloads an optical disk; the transmission motor 15 starts to rotate the gear module 16 reversely to move the slider 18 forward. First, the end of traverse 12 where spindle motor 13 is disposed on shifts down to move the spindle motor 13 away from the center hole of the optical disk D and away from the disk-withdrawing path. Then the slider 18 drives the unloading arm 20 to rotate reversely to withdraw the optical disk D.

In the conventional slot-in optical disk drive 10, the support cover 17 is used to fix the gear module 16 and separate the gear module 16 to prevent an optical disk or external object from jamming in and obstructing the rotating of the gear module 16. As shown in FIG. 2, a structure for fixing the gear module 16 of a conventional slot-in optical disk drive generally includes a bolt 22 protruding from the bottom of the casing 11. A screw hole 23 is disposed in the bolt 22. The bolt 22 passes through a wheel hole 25 of a gear 24 in the gear module 16, and the bolt 22 is higher than an end face of the wheel hole 25 by a distance h. Besides, a through hole 26 is disposed on the support cover 17 and is opposite to the screw hole 23. Then, a screw 27 passes the support cover 17 from the through hole 26 to be screwed in the screw hole 23, so that the gear 24 is fixed between the support cover 17 and the casing 11 and rotates around the bolt 22.

However, the distance h is quite limited for thinning the slot-in optical disk drive. When the screw 27 is screwed in excessively, the support cover 17 is forced to deform and touch an end face of the wheel hole 25 so that the distance h is eliminated. As shown in FIG. 3, in the attempt to reduce the total weight of the slot-in optical disk drive, the support cover 17 is made of a certain plastic material which results in poorer structural strength. Hence, the smaller supporting face of the bolt 22 is prone to sink in the support cover 17 and the support cover 17 presses on an end face of the wheel hole 25 directly. As such, not only the rotation of the gear 24 is obstructed and the loading and unloading of the slot-in optical disk drive are affected, but rotating noises of the gear 24 are also generated to degrade the playing quality of the optical disk drive. Thus, there are still several issues on the gear holder of the gear in conventional optical disk drives to be solved.

### SUMMARY OF THE INVENTION

An object of the present invention is to provide a gear holder in an optical disk drive. A flange downwardly protrudes under the peripheral of a through hole of a support cover to enhance the structural strength of the peripheral of the through hole, so as to prevent the support cover from deforming and touching the gear.

Another object of the present invention is to provide a gear holder in an optical disk drive, wherein a flange protrudes to enlarge the distance to absorb the deformation of the support cover when the support cover is screwed in, so that the distance for the gear rotation is maintained to lower the rotating noise of the optical disk drive.

For achieving the objects mentioned above, according to a preferred embodiment of the gear holder in an optical disk drive, a bolt upwardly protrudes from the bottom of a casing. A screw hole is disposed in the center of the bolt inserted by a wheel hole on the center of a gear. The height of the wheel hole is lower than the height of the bolt. A ring flange protrudes under the peripheral of a through hole disposed on a support cover. The width of the ring flange is equal to the width of the bolt, and the height thereof is equal to the height difference from the bolt to the wheel hole. The support cover is fastened on the bolt with the flange pressed on the top of the bolt by a screw screwed in the screw hole, and then the gear is held and rotates between the casing and the support cover. The height of the flange plus the height difference from the bolt to the wheel hole equals the rotation space of the gear.

### BRIEF DESCRIPTION OF THE DRAWINGS

FIG. 1 is a top view of a conventional slot-in optical disk drive.

FIG. 2 is a side exploded view of a conventional gear holder.

FIG. 3 is a side sectional view of a conventional gear holder assembly.

FIG. 4 is a side sectional view of an exploded gear holder according to the invention.

FIG. 5 is a side sectional view of a gear holder assembly according to the invention.

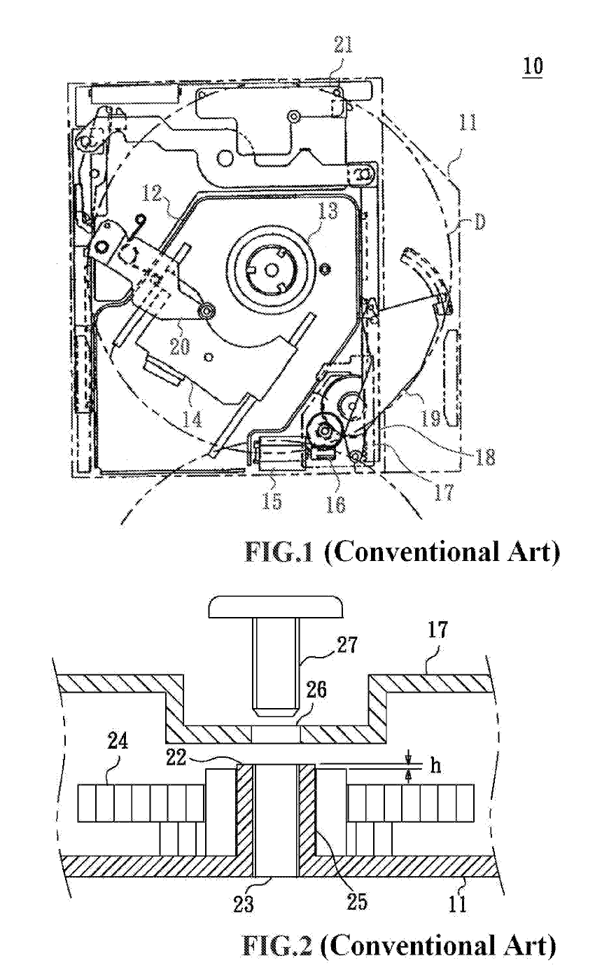

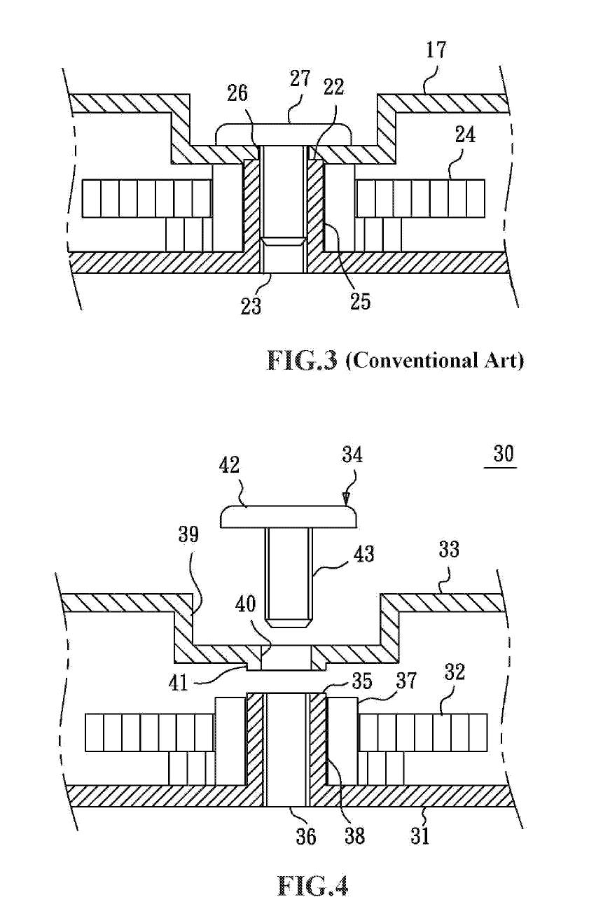

### DETAILED DESCRIPTION OF THE INVENTION

For achieving the objects mentioned above, detailed description regarding techniques used and effects is given in the following embodiments with reference to the accompanying drawings.

Referring to FIG. 4, which is a lateral cross-sectional view of an exploded gear holder in an optical disk drive according to the present invention. The gear holder 30 of an optical disk drive includes a casing 31, a gear 32, a support cover 33 and a screw 34. The screw 34 passes the support cover 33 and fixes the gear 32 on the casing 31 for the gear 32 to rotate freely between the casing 31 and the support cover 33, so as to transmit the kinetic energy for loading and unloading of the optical disk drive.

The casing 31 thereof is basically the lower casing of the optical disk drive. A bolt 35 protrudes upwardly from the bottom of the casing 31. The bolt 35 is a cylinder with a screw hole 36 passing through the center thereof. The gear 32 is composed of two up and down gears of different diameters and stacked concentrically, and a wheel circle 37 is the center thereof. A round wheel hole 38 is disposed in the center of the wheel circle 37 with a diameter for the bolt 35 to be inserted in and can rotate freely. The height of the wheel hole 38 is slightly lower than the height of the bolt 35.

The support cover 33 is a plate made of plastic material for supporting and fixing the gear 32, especially for covering and separating a transmission gear module of a slot-in optical disk drive. A cavity 39 is downwardly concaved on the support cover 33 and is opposite to the bolt 35. The diameter of the cavity 39 is larger than those of the bolt 35 and the wheel circle 37. A through hole 40 passes through the center of the cavity 39 and is opposite to the screw hole 36 on the bolt 35. The diameter of the through hole 40 approximately equals that of the screw hole 36. A flange 41 downwardly protrudes under the peripheral of the through hole 40. The flange 41 can be ring-shaped, and the height thereof approximately equals the height difference from the bolt 35 to an end face of the wheel hole 38, while the width thereof approximately equals that of the bolt 35. In addition, the screw 34 is provided with a screw nut 42 and a screw post 43. The screw nut 42 has a diameter which approximately covers the bolt 35 and the wheel circle 37, but is smaller than that of the cavity 39. The screw post 43 has a diameter which allows being screwed into the screw hole 36.

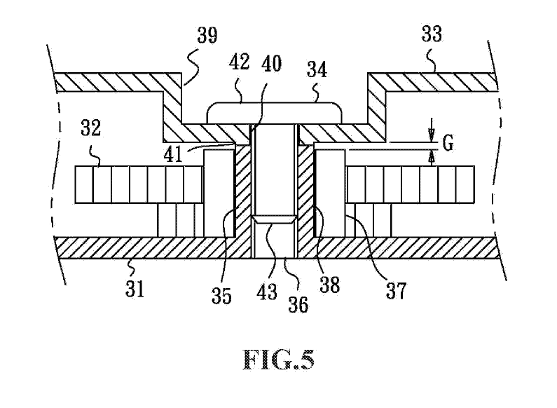

As shown in FIG. 5, which is a lateral cross-sectional view of an assembled gear holder in an optical disk drive according to the present invention. During assembly, the wheel hole 38 of the gear 32 is inserted by the bolt 35 first, and the gear 32 leans on the casing 31 for an end face of the bolt 35 to pass through the wheel hole 38. Then, the screw post 43 of the screw 34 passes the through hole 40 of the support cover 33 and is screwed in the screw hole 36 of the bolt 35 for keeping the screw nut 42 in the cavity 39. At the same time, the gear 32 is fixed between the casing 31 and the support cover 33 for the flange 41 which protrudes downwardly under the peripheral of the through hole 40 to press on an end face of the bolt 35. The height of the flange 41 plus the height difference from the bolt 35 to the wheel hole 38 equals a distance G between the wheel circle 37 and the support cover 33. Thus the gear 32 has a larger distance G for rotation, and besides, the flange 41 increases the thickness of the peripheral of the through hole 40 and increases the structural strength of the support cover 33 to reduce the deformation thereof. Even if the deformation occurs, the increased distance G can effectively absorb the deformation to prevent the support cover 33 from pressing the gear 32.

Thus, according to the gear holder in an optical disk drive of the present invention, a ring flange downwardly protrudes under the peripheral of the through hole and increases the structural strength of the peripheral of the through hole of the support cover to prevent the deformation of the support cover. Meanwhile, the protruding ring flange increases the distance between the gear and the support cover to absorb the deformation when the support cover is screwed in, and maintains an effective distance for the gear rotation, so as to reduce the noise generated from the gear's friction during rotation. In addition, although a single gear is described in the above embodiment of the gear holder in an optical disk drive, other gears in an optical disk drive also can have the same structure to have the same effect as described in the invention.

The examples cited above are meant to explain the invention and should not be construed as a limitation on the actual applicable scope of the invention, and as such, all modifications and alterations without departing from the spirits of the invention and appended claims shall remain within the protected scope and claims of the invention.

What is claimed is:

1. A gear holder in an optical disk drive, comprising:
a casing, a bolt upwardly protruding from a bottom of the casing, a screw hole being disposed in the bolt;
a gear, a wheel hole being disposed in a center of the gear, the wheel hole being inserted by the bolt;
a support cover, a through hole being disposed thereon, a flange protruding from a peripheral under the through hole; and
a screw passing through the through hole and screwed in the screw hole to fix the support cover to the bolt, the flange pressing on the top of the bolt for fixing the gear to rotate between the casing and the support cover.

2. The gear holder in an optical disk drive according to claim 1, wherein the support cover is made of a plastic material.

3. The gear holder in an optical disk drive according to claim 1, wherein the wheel hole is inserted by the bolt and a height of the wheel hole is lower than a height of the bolt.

4. The gear holder in an optical disk drive according to claim 3, wherein the width of the flange equals the width of the bolt.

5. The gear holder in an optical disk drive according to claim 3, wherein the height of the flange equals the height difference from the bolt to the wheel hole.

6. The gear holder in an optical disk drive according to claim 5, wherein the height of the flange plus the height difference from the bolt to the wheel hole equals a distance for the gear rotation.

7. The gear holder in an optical disk drive according to claim 1, wherein the flange is ring-shaped.

8. The gear holder in an optical disk drive according to claim 1, wherein the support cover is a plate for covering and separating a transmission gear module of the slot-in optical disk drive.
